(19) United States
(12) Patent Application Publication
(10) Pub. No.: US 2007/0068274 A1
(43) Pub. Date: Mar. 29, 2007

(54) Peripheral artery medical device durability tester and method

(75) Inventors: Jonathan M. Olson, San Jose, CA (US); Peter E. Rosario, Fremont, CA (US); Donald J. Cabaluna, Foster City, CA (US); Guruswami Ravichandran, Arcadia, CA (US); George D. Hermann, Portola Valley, CA (US); Marshall Tsuruda, San Jose, CA (US)

Correspondence Address: HAYNES BEFFEL & WOLFELD LLP, P O BOX 366, HALF MOON BAY, CA, 94019, US

(73) Assignee: VASCULAR ARCHITECTS, INC., a Delaware Corporation, San Jose, CA (US)

(21) Appl. No.: 11/364,825

(22) Filed: Feb. 28, 2006

Related U.S. Application Data
(60) Provisional application No. 60/657,504, filed on Mar. 1, 2005.

(51) Int. Cl. G01N 3/00

(52) U.S. Cl. 73/788

(57) ABSTRACT

Apparatus tests the durability of a peripheral artery medical device based upon anatomical loading conditions. A peripheral artery medical device is mounted to a support element, typically a hollow tube, having first and second end portions. End holding elements are mounted to a base and are secured to the first and second end portions. The apparatus further comprises means for applying a plurality of cycles of at least one of the following loading conditions to the medical device support element at the location of the peripheral artery medical device: torsion, tension/compression, bending and pinching. In some embodiments the apparatus comprises an environmental chamber housing at least the support element so to mimic the service temperature environment of the medical device. A method for testing the durability of a peripheral artery medical device based upon anatomical loading conditions is also disclosed.

### CROSS-REFERENCE TO OTHER APPLICATIONS

This application claims priority from U.S. Provisional Application No. 60/657,504 filed Mar. 1, 2005, titled “Apparatus and Methods for Durability Testing of Peripheral Artery Medical Devices”.

### FEDERALLY SPONSORED RESEARCH OR DEVELOPMENT

None.

### BACKGROUND OF THE INVENTION

Medical devices, such as stents and covered stents, used in the peripheral arteries to treat a number of arterial diseases (including atherosclerosis, aneurysm, injury with pseudoaneurysm, etc.) are subject to forces not seen in coronary artery implants. These forces have come to light in a number of different forums, including peer reviewed journal articles, implant clinical trials, and changes in federal guidelines for design validation of stents. The arteries of the periphery, such as the superficial femoral and the popliteal are long arteries with a relatively small number of side branches. This lack of tethering allows the arteries to flex and deform with the movements of the muscles and tendons (for example during knee and hip flexion). The forces that the artery can encounter include: torsion, axial tension/compression, pinching or kinking (radial compression), and bending. These forces can work in unison or individually.

### BRIEF SUMMARY OF THE INVENTION

Previous requirements for product release in this field, that is medical devices used in the peripheral arteries, typically included a theoretical analysis for the implants' delivery and the forces an implant would encounter from the pulsatile artery movement for blood flow. While these tests are important, it is believed that these tests not sufficient to ensure adequate durability for implants that are placed in the highly mobile peripheral arteries. It is believed that for proper testing, the forces these implants are expected to encounter need to be replicated by mechanical testing.

First aspect of the present invention is directed to apparatus for testing the durability of a peripheral artery medical device based upon anatomical loading conditions. A support element has first and second end portions and a body therebetween. A peripheral artery medical device is mounted to the support element. The body defines a centerline. The apparatus also includes means for engaging the support element. The apparatus further comprises means for applying a plurality of cycles of at least one of the following loading conditions to the support element at the location of the medical device: torsion, tension/compression, bending and pinching. A cycle counter is used to count the cycles of the at least one loading condition. In some embodiments an environmental chamber is used to house at least the support element so to mimic the service temperature environment of the medical device. The support element may comprise hollow tubing housing the peripheral artery medical device.

A second aspect of the invention is directed to apparatus for testing the durability of a peripheral artery medical device based upon anatomical loading conditions. A support element has first and second end portions and a body therebetween. A peripheral artery medical device is mounted to the support element. The body defines a centerline. End holding elements are mounted to the base and are secured to the first and second end portions of the medical device support element. The apparatus further comprises means for applying a plurality of cycles of at least one of the following loading conditions to the medical device support element at the location of the peripheral artery medical device: torsion, tension/compression, bending and pinching. In some embodiments the apparatus comprises an environmental chamber housing at least the support element so to mimic the service temperature environment of the medical device. The loading conditions applying means may act through the end holding elements to apply at least one of torsion and tension/compression loading conditions. The loading conditions applying means may also contact the medical device support element at a position between the end holding elements to apply at least one of bending and pinching loading conditions.

A third aspect of the invention is drifted to a method for testing the durability of a peripheral artery medical device based upon anatomical loading conditions. A peripheral artery medical device is loaded to a support element, the support element having first and second end portions and a body therebetween, the body defining a centerline. The support element is engaged by testing apparatus. The durability of the peripheral artery medical device is tested by applying a plurality of cycles of at least one of the following loading conditions to the support element by the testing apparatus: torsion, tension/compression, bending and pinching. The testing is monitored. In some embodiments the testing is carried out in an environmental chamber housing at least the support element so to mimic the service temperature environment of the medical device.

The present invention is particularly useful for the testing of stents for use in the peripheral arteries (e.g., superficial femoral, popliteal, carotid). The invention provides anatomically relevant physical testing platforms for the accelerated development of stent implants as well as other peripheral artery medical devices. The inventions also allow for side-by side comparison of the durability and performance of specific implant designs.

The inventions disclosed have a number of varying components that when combined allow for anatomically relevant physical testing platforms. Aspects of the invention include the individual force testers, the body temperature chamber to house the testers and the support system for the test articles.

Various features and advantages of the invention will appear from the following description in which the preferred embodiments have been set forth in detail in conjunction with the accompanying drawings.

### BRIEF DESCRIPTION OF THE DRAWINGS

FIG. 1 is an overall view of test article capture tubing used with the present invention.

FIG. 2 is an overall view of an atherosclerotic model capture tubing used with the present invention.

FIG. 3 is an overall view of a test environment heat chamber used with the present invention.

FIG. 4 is an overall view of a compression/elongation tester made according to the invention.

FIG. 5 is an overall view of a torsion tester made according to the invention.

FIG. 6 is an overall view of a pinch tester made according to the invention.

FIG. 7 is an alternative embodiment of the pinch tester of FIG. 6 using a rack and pinion arrangement.

FIG. 8 is an alternative embodiment of the pinch tester of FIG. 7 using an air piston powered arrangement.

FIG. 9 is an overall view of a bend tester made according to the invention.

FIG. 10 is an alternative embodiment of testing system comprising at a self-contained environment and tester.

FIG. 11 is an alternative embodiment of the pinch tester of FIG. 8 using a high speed wheel arrangement.

FIG. 12 is an alternative embodiment of the torsion tester of FIG. 5 using a cam operation arrangement.

### DETAILED DESCRIPTION OF THE INVENTION

The following description of the invention will typically be with reference to specific structural embodiments and methods. It is to be understood that there is no intention to limit the invention to the specifically disclosed embodiments and methods but that the invention may be practiced using other features, elements, methods and embodiments. Like elements in various embodiments are commonly referred to with like reference numerals.

The support system for testing peripheral artery medical devices, sometimes referred to as implants, is typically in the form of tubing 13, such as Dow Corning Pharma-80 silicone tubing (FIG. 1). Tubing 13 is preferably chosen to resemble the stiffness of an aged or diseased artery. Tubing 13 should be available in different internal diameters for use with different implant sizes. It is also advantageous to allow for the stent, or other peripheral artery medical device, to be loaded as intended during clinical use, i.e., allow for use in a 37 C environment (water or air) and allow for balloon dilatation. Similarly tubing 13 must remain stable during force application.

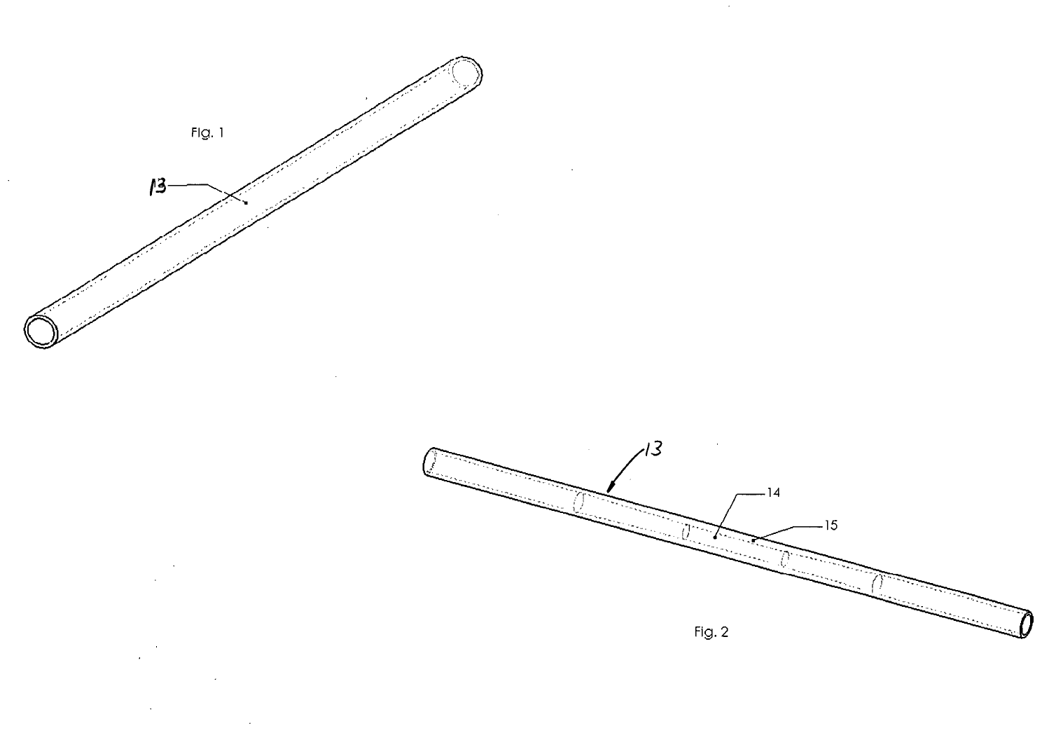

An alternative embodiment of tubing 13 of FIG. 1 is shown in FIG. 2 used as an artherosclerotic disease modeled vessel. As shown in FIG. 2, tubing 13 includes one or both of a narrowed section 14 and a localized stiffening section 15 in the tubing wall to simulate diseased sections.

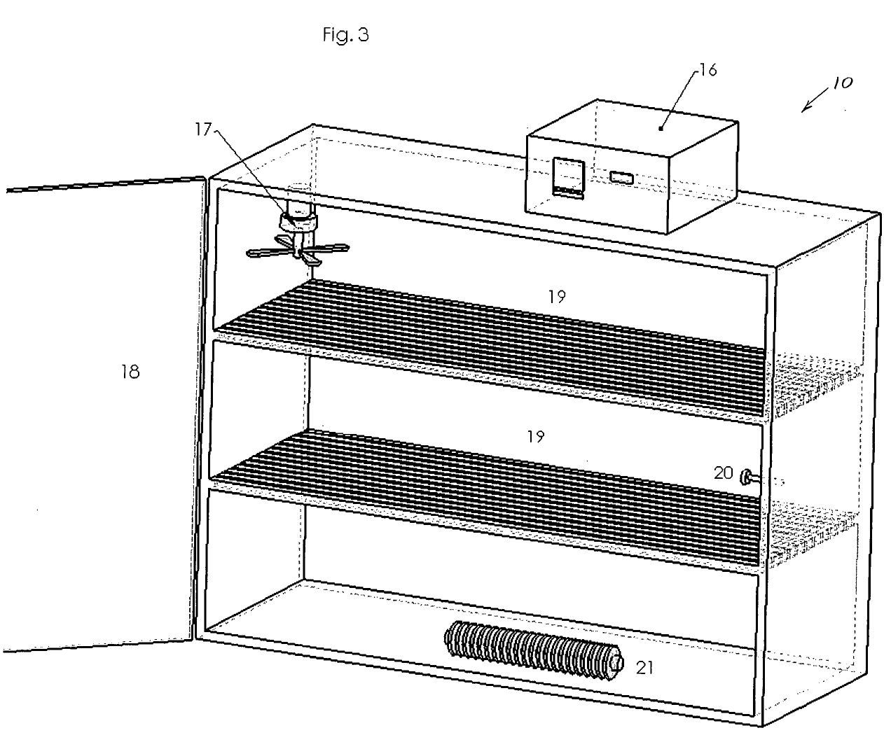

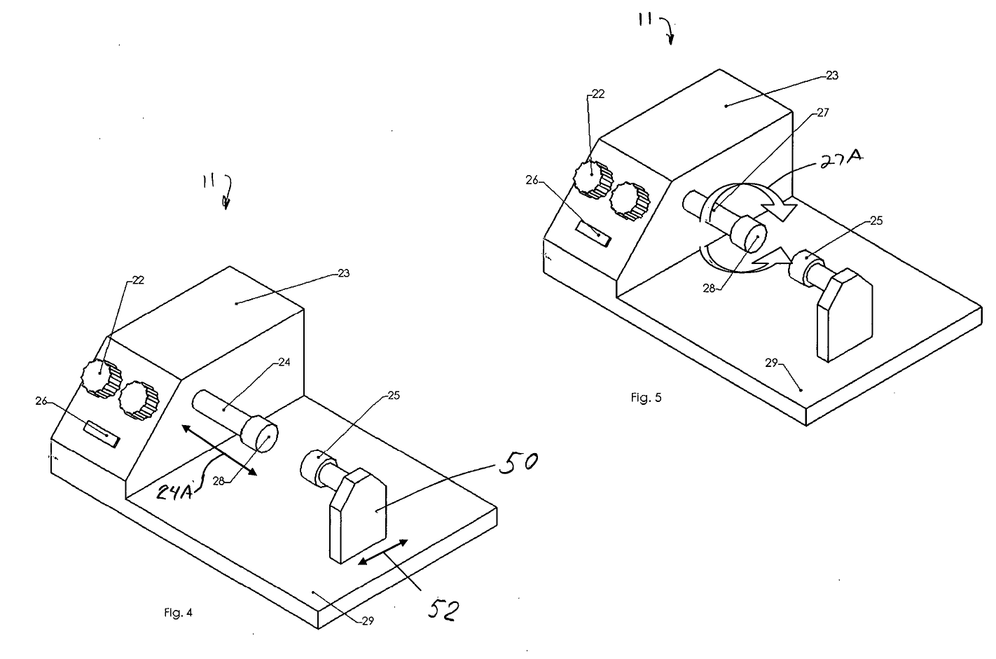

An environmental test chamber 10, shown in FIG. 3, can be important to the testing of implants due to the heat dependence of the materials utilized for implants. Self-expanding stents are often made of a nickel titanium alloy, which utilizes transition temperatures to aid in their flexibility. Testing of these implants in a room-temperature environment is often not appropriate for an implant that is used at body temperature. A heat chamber that consistently maintains body temperature (37 C) for multiple testing apparatus is particularly useful for physical testing. The use of large slotted shelves 19 allow for the heat to distribute evenly. Test chamber 10 uses a heating element 21, thermocouples 20, feedback electronics, circulation fan 17 for air movement, and sealable doors 18 to maintain temperature during testing. A controller 16 uses feedback electronics to control circulation fan 17 and heating element 21 to control the temperature within chamber 10. An alternative embodiment of this air heat chamber 10, not shown, is an individual chamber just around the test article that utilizes heated (37 C) fluid to maintain test article temperature.

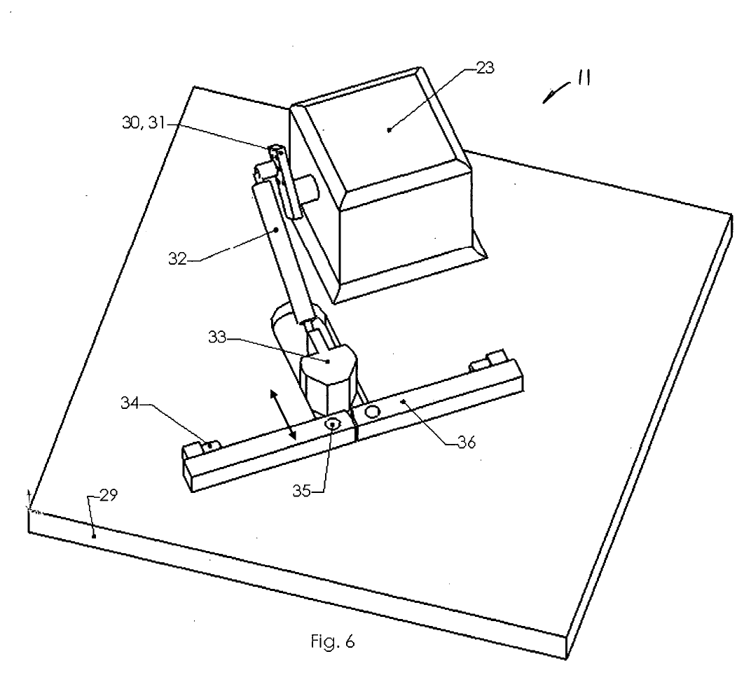

Testers 11, discussed below with reference to FIGS. 4-12, preferably include the following: a comparable tubing holding device (pins sized to the tubing ID work well), ease of viewing the sample during testing—clear or open test articles, and testing parameter adjustment (e.g. speed, force, displacement adjustments). Magnet-actuated or photo electronic counters allow for accurate measurement of cycles to failure or test completion. Testers 11 are designed to simulate a specific force and/or a specific range of motion that the medical device is likely to encounter when used in the body. All test indenters are preferably consistently in contact with the tubing surface so that they do not impart unwanted force applications (ramming or loaded forces).

The various embodiments of testers 11 include a base 29 supporting a motor assembly 23. Motor assembly 23 could include various types of drives including servo motors, worm gears, compressed air systems, etc. Speed and travel controllers 22 are also mounted on based 29 and allow for modifications of the speed (cycles/min) or the travel (percentage of force application or distance of force mechanism movement).

The torsion tester 11 of FIG. 5 uses two rubber mounting grommets 28 and tubing collars 25 to act as holding arms to suspend a flexible tube 13, which in turn, holds the test specimen. Tubing collars 25 are used for holding the test article tubing 13. A pin, not shown, is typically placed into the center of tubing 13 and then a grommet 28 is squeezed around the pin/tubing assembly by the tubing collars. The mounting grommets 28 are typically made of rubber and are sized for the specific tubing 13 being used. Grommets 28 tighten around tubing 13 thus allowing force to be transferred efficiently. Grommets 28 also prevent unwanted movement of tubing 13.

An actuation device, not shown, within motor assembly 23, such as a stepper motor, optical encoder, compressed air driver, etc., rotates torsion tester rotating arm 27, typically at rotation angles of between 0° and 90° in each direction, as indicated by an arrow 27A. The rotation of arm 27 creates a twist on tubing 13, placing the specimen in a torsion loading condition. The degree of twist or rotation imparted to the specimen should be adjustable to be consistent with measured or estimated rotation data from the clinical environment. Cycles are recorded on a cycle counter 26, which are used to document the cycle life of a given specimen for a particular test.

The axial compression/elongation tester 11 (see FIG. 4) also uses a grommet based holding system for the tubing containing the test specimen. The tester 11 of FIG. 4 includes a compression/elongation tester actuation arm 24. The distances arm 24 moves in and out, indicated by arrow 24A, create the compression and elongation of the test article. This travel is controlled by controller 22. The amount of compression/elongation is typically between 1% and 50% of the length of tubing 13. The position of support 50 on base 29 may be laterally adjusted as indicated by arrow 52 to permit off-axis testing. One end of tubing 13 is adjustable for varying specimen lengths and also for varying the degree of off-axis compression/elongation desired. The percentage of compression or elongation can be modified, either dependently or independently.

A bend tester 11 (see FIG. 9) allows for test articles to be bent over a consistent specified radius 40. Radius 40 should be changeable, typically from a minimum radius of 5 mm to as large as 12 cm. A fully adjustable bend fixture 40A allows a stent-loaded tubing 13 to bend around a specific curve (though a specific arc). A cam-driven arm or other movement device implements the bend action. The tubing should not whip and therefore a stiffening strip may be included with the tubing to support the return action. In the embodiment of FIG. 9, a rotation arm 30, 31 and a cam arm 32 are used to drive a force indenter 33. The amount of travel, indicated by arrow 33A, imparted to indenter 33 can be adjusted through different attachment points 32A on cam arm 30, 31. Indenter 33 is housed within and is guided by a cam groove 41 to allow straight, consistent motion of the cam arm 32 and indenter 33.

Force indenter 33 used to impart the force and area of force onto tubing 13 that contains the test specimen (typically a stent). Indenter 33 is always in contact with tubing 13 to ensure that there is no ramming force imparted on the test sample. Indenter 33 can be modified for height, width and tip radius to impart varying amounts of force onto the stent.

The bend tester 11 of FIG. 9 also includes a bend indenter guide plate 38 used to ensure that tubing 13 remains in contact with bend indenter 33 at all times during the travel. It also prevents tubing 13 from coming out of the bend path. A bend tubing holder 39 allows for tubing 13 to remain in the bend travel path. It also facilitates review and adjustment of the stent loaded tubing during the durability testing.

A pinch tester 11, see FIG. 6, allows for compression of the test article perpendicular to the axis or centerline. This pinch force replicates what may be the most important force applied to stents during movement. Adjustable travel parameters allow for testing long-term accelerated durability as well as shorter-term design modification durability. The indenter (force applicator) 33 applies force over a relatively uniform area. This area should be scalable to allow for varying force application. Motor assembly 23 can include a motor, cam, rack and pinion, air, or other mechanical power system to apply the force. A back plate can be used to support the tubing/stent during force application, which can be hinged to allow for freer movement than a rigid back plate would allow. In the embodiment of FIG. 6, a moveable back plate 36 is used to allow the stent tubing assembly 13 to shift as it would anatomically. Movable back plate 36 holds the stent/tubing assembly 13 correctly aligned with force indenter 33. Tubing holders 34 are used for holding the stent to the moveable back plate 36. Movable back plate 36 also allows for easy viewing and access to the stent/tubing assembly 13 for review during testing. This additional movement may better replicate the movement of an artery in its surrounding tissue bed. Hinge points 35 are located on either side of the center of tubing 13, thus allowing a smooth bending of the tubing. Hinge points 35 allow back plate 36 to move with the application of force indenter 33 to allow tubing/stent assembly 13 to shift as it would anatomically.

The tester allows for accurate cycle counting. The machine also allows for varying the test article sizes (lengths and diameters).

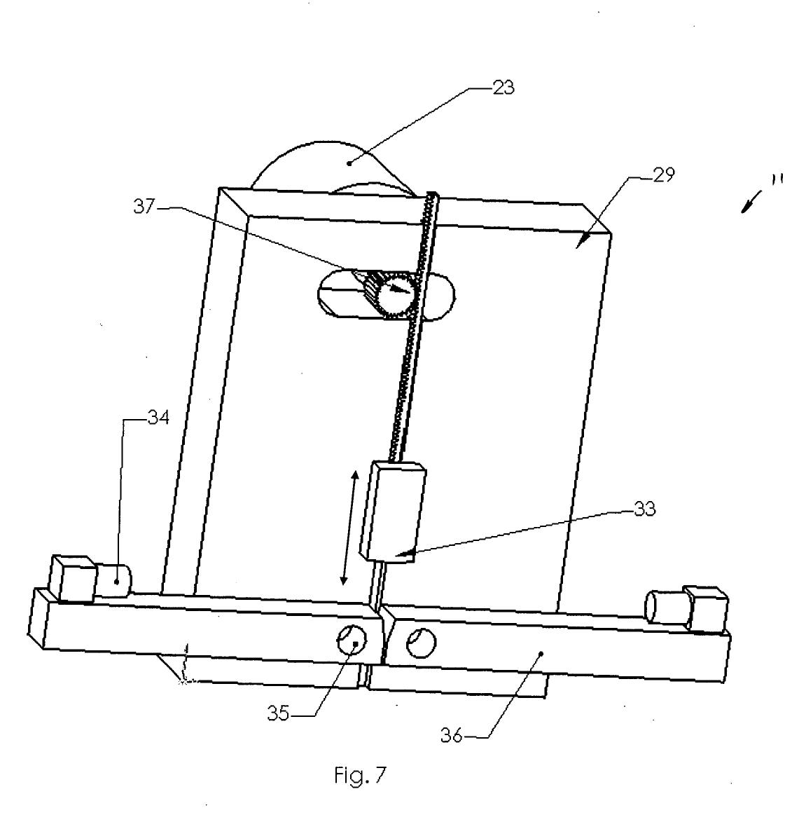

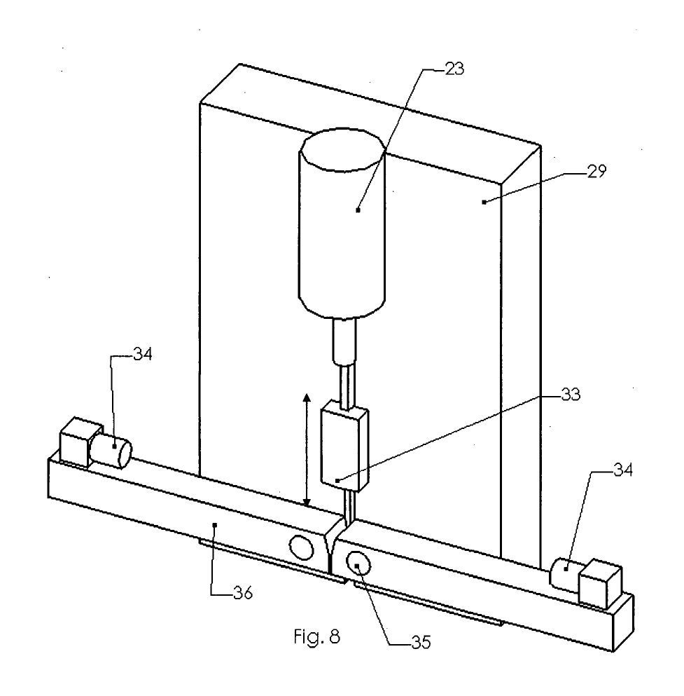

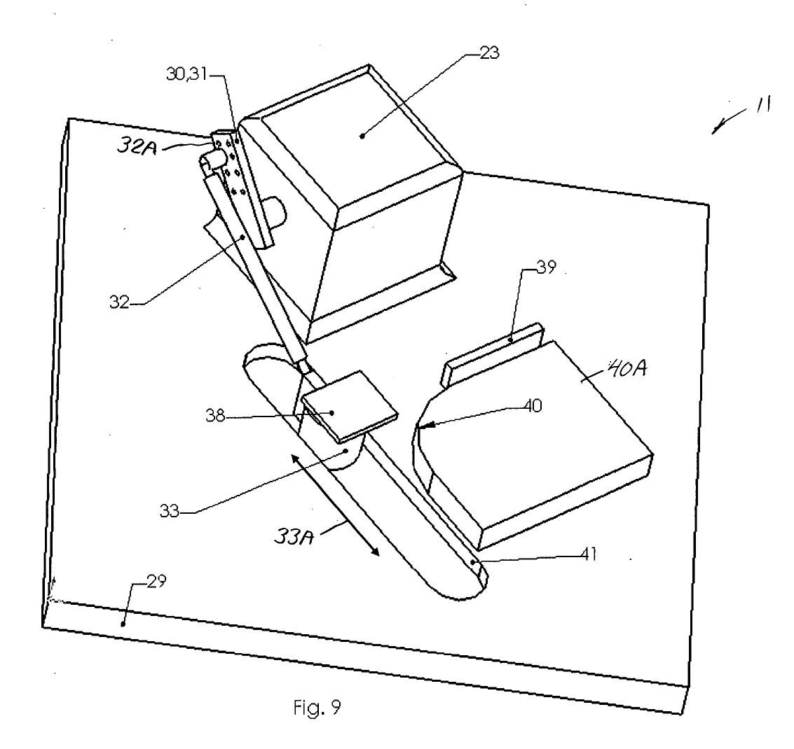

A number of alternative embodiments of pinch tester 11 of FIG. 6 are shown in FIGS. 7, 8, and 11. Tester 11 of FIG. 7 uses a small base 29 and a rack and pinion movement system 37. System 37 uses a gear and toothed rod for moving the force applicator 33. This embodiment aides in the efficiency of the tester 11 by allowing the system in be run at a higher speed. Tester 11 of FIG. 7 is adjustable for stroke and contact time. The FIG. 8 embodiment of tester 11 is similar to the FIG. 7 embodiment but uses a compressed air motor assembly 23 to move force indenter 33.

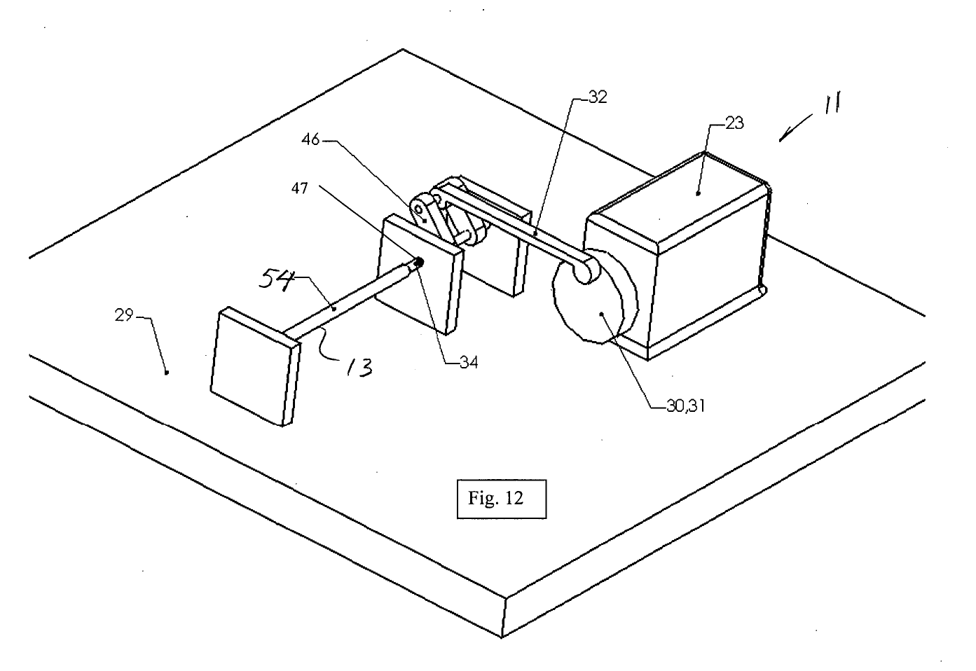

The tester 11 of FIG. 11 uses a rotating wheel 44 with indents to cause force indenter 33 to impinge on the test article. Wheel 44 contains raised and lower section onto which an indenter shaft 45 rides. Wheel 44 can spin at a much higher speed and allow for consistent travel of indenter 33. Fewer moving parts allow for fewer failure points. The number and size of raised and lowered areas can be modified for different desired indenter travels. Indenter shaft 45 contains a rounded tip to allow for smooth operation on the raised and lowered sections of wheel 44.

An alternative embodiment of the torsion tester 11 of FIG. 5 is shown in FIG. 12 and utilizes a cam-operated twisting mechanism. Cam arm 32 drives rotation arm 46 to allow the torsion force to be smoothly transferred to the tubing assembly, including tubing 13 loaded with a test article 54, such as a stent. This drive assembly allows for movement up to just less than 90° in each direction, that is clockwise and counterclockwise. Bearings 47 at each tubing holder joint allow for increased efficiency of force application.

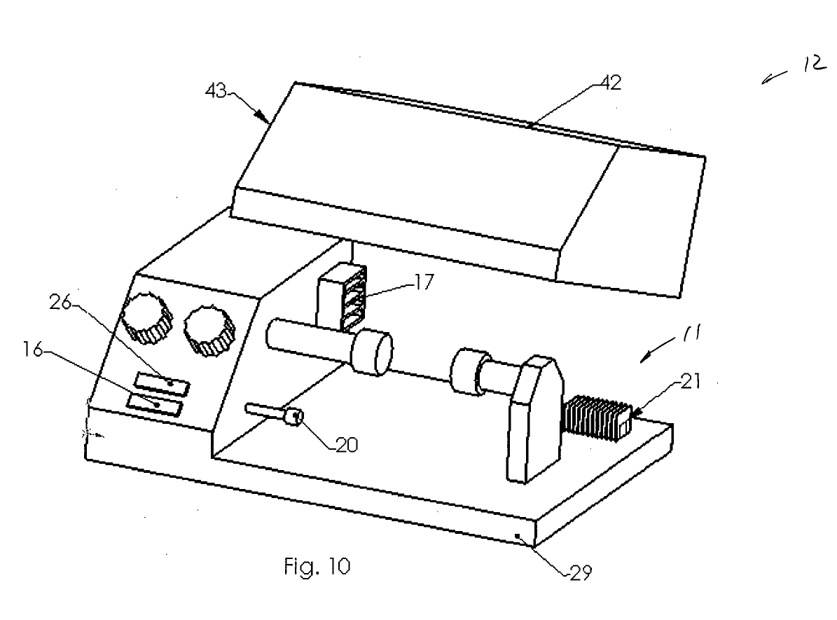

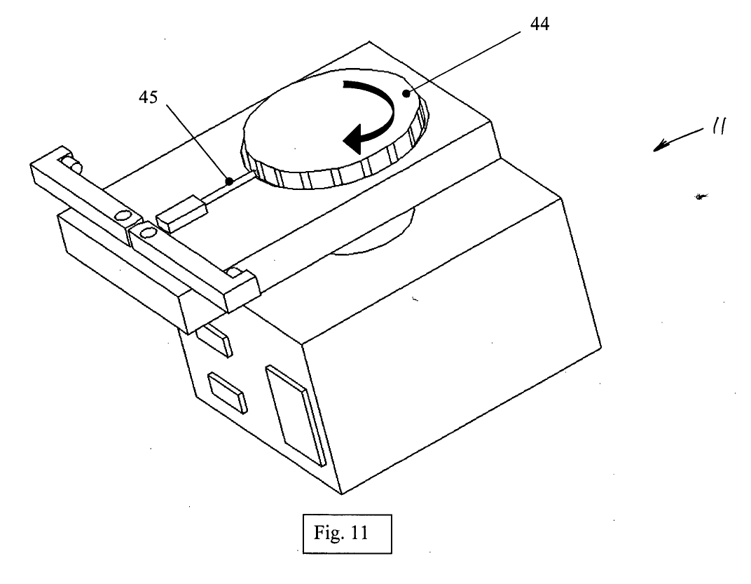

FIG. 10 illustrates a self-contained testing system 12 that combines the structure and functions of axial compression/elongation tester 11 of FIG. 4 with the environmental test chamber 10 of FIG. 3. System 12 comprises a transparent cover 42 to create, along with circulation fan 17, heating element 21 and thermocouple 20, a self contained tester/testing environment. Cover 42 allows system 12 to operate independent of a larger heating environment. Seals 43 may be provided on all edges to ensure consistent temperatures during testing.

A multi-axis tester, not shown, may be constructed to test all of the forces at one time. Such a multi-axis tester would preferably have independent parameter adjustment for each of the forces.

The tubing, heat chamber and testers work together to provide a repeatable means to assess the durability of stent implants in a repeatable, accelerated time frame. Specific parameter settings are adjustable to the latest clinical information regarding appropriate parameter values. These parameter values (e.g., force, displacement, artery bend radius) can come from angiographic measurements, peer-reviewed, biomedical engineering and cardiovascular literature. The advantage of having a test system that can simulate the clinical parameters allows for rapid assessment of potential design changes of a device, as well as validating the durability of a selected design.

What is claimed is:

1. Apparatus for testing the durability of a peripheral artery medical device based upon anatomical loading conditions comprising:
a support element to which a peripheral artery medical device is mounted, the support element having first and second end portions and a body therebetween, the body defining a centerline;
means for engaging the support element;
means for applying a plurality of cycles of at least one of the following loading conditions to the support element at the location of the medical device: torsion, tension/compression, bending and pinching;
means for counting the cycles of the at least one loading condition.

2. The apparatus according to claim 1 wherein at least one of the loading conditions is applied along a line other than the centerline.

3. The apparatus according to claim 1 further comprising an environmental chamber housing at least the support element so to mimic the service temperature environment of the medical device.

4. The apparatus according to claim 1 wherein the support element comprises hollow tubing housing the peripheral artery medical device.

5. The apparatus according to claim 1 wherein the loading conditions applying means acts through the support element engaging means to apply at least one of torsion and tension/compression loading conditions.

6. Apparatus for testing the durability of a peripheral artery medical device based upon anatomical loading conditions comprising:
a base;
a medical device support element to which a peripheral artery medical device is mounted, the medical device support element having first and second end portions and a body therebetween, the body defining a centerline;
end holding elements mounted to the base and secured to the first and second end portions of the medical device support element; and
means for applying a plurality of cycles of at least one of the following loading conditions to the medical device support element at the location of the peripheral artery medical device: torsion, tension/compression, bending and pinching.

7. The apparatus according to claim 6 further current comprising means for counting the cycles of the at least one loading condition.

8. The apparatus according to claim 6 further comprising an environmental chamber housing at least the support element so to mimic the service temperature environment of the medical device.

9. The apparatus according to claim 8 wherein the base constitutes a portion of the environmental chamber.

10. The apparatus according to claim 6 wherein the loading conditions applying means acts through the end holding elements to apply at least one of torsion and tension/compression loading conditions.

11. The apparatus according to claim 6 wherein the loading conditions applying means contacts the medical device support element at a position between the end holding elements to apply at least one of bending and pinching loading conditions.

12. A method for testing the durability of a peripheral artery medical device based upon anatomical loading conditions comprising:
mounting a peripheral artery medical device to a support element, the support element having first and second end portions and a body therebetween, the body defining a centerline;
engaging the support element by testing apparatus;
testing the durability of the peripheral artery medical device by applying a plurality of cycles of at least one of the following loading conditions to the support element by the testing apparatus: torsion, tension/compression, bending and pinching; and
monitoring the testing.

13. The method according to claim 12 further comprising carrying out the testing in an environmental chamber housing at least the support element so to mimic the service temperature environment of the medical device.

14. The method according to claim 12 wherein the testing is carried out so that at least one of the loading conditions is applied along a line other than the centerline.

15. The method according to claim 12 wherein the monitoring step comprises counting the cycles of the loading condition.

16. The method according to claim 12 wherein the mounting step comprises placing the peripheral artery medical device within a hollow tubular support element.
